(19) United States
(12) Patent Application Publication
(10) Pub. No.: US 2011/0167149 A1
(43) Pub. Date: Jul. 7, 2011

(54) INTERNET FLOW DATA ANALYSIS METHOD USING PARALLEL COMPUTATIONS

(75) Inventors: Youngseok Lee, Daejeon (KR); Wonchul Kang, Daejeon (KR); Hyeongu Son, Seoul (KR)

(73) Assignee: The Industry & Academic Cooperation in Chungnam National University, Daejeon (KR)

(21) Appl. No.: 12/951,695

(22) Filed: Nov. 22, 2010

(30) Foreign Application Priority Data
Jan. 6, 2010 (KR) 2010-0000709

(51) Int. Cl. G06F 15/173

(52) U.S. Cl. 709/224

(57) ABSTRACT

A method of analyzing internet flow data includes: (A) an internet flow data input step of dividing internet flow data stored in a file system and receiving the divided data at one or more data nodes; (B) a Map task step of producing, with respect to each of the data nodes, a (Key, Value) pair from the received data and temporarily storing the (Key, Value) pair; and (C) a Reduce task step of calculating a (Key, SUM(Value)) value from the stored (Key, Value) value and storing the calculated (Key, SUM(Value)) value. In accordance with the method, the analysis task is not performed in one server, but distributed into a plurality of server and then performed. Accordingly, internet flow data can be analyzed within a shorter period.

### CROSS-REFERENCES TO RELATED APPLICATION

This application claims under 35 U.S.C. §119(a) the benefit of Korean Patent Application No. 10-2010-709 filed on Jan. 6, 2010, the entire disclosure of which is incorporated by reference herein.

### BACKGROUND OF THE INVENTION

1. Technical Field

The present invention relates to a method of analyzing internet flow data and, more, particularly, to a method of analyzing internet flow data, in which an analysis task conventionally performed by one server may be distributed into a plurality of servers and processed in parallel, when an internet traffic analysis task based on internet flow data is performed by internet traffic monitoring equipment.

2. Related Art

The measurement of internet traffic, indicating the amount of data transmitted over a network, is important in the field of computer network. For example, the measurement of internet traffic is essential in checking the operating state of a network and internet traffic characteristics, performing design and planning, blocking harmful internet traffic, carrying out billing, and guaranteeing Quality of Service (QoS).

The measurement of internet traffic may be divided into an active measurement method and a passive measurement method. The active measurement method is a method of directly and additionally carrying test packets over a network and measuring a result of the test packets. The active measurement method is advantageous in that it can easily obtain metrics, such as unidirectional latency, packet loss, and a latency variation. However, the active measurement method has a disadvantage in that measurement results are inaccurate and normal internet traffic is influenced because actual internet traffic is not measured by a user, but is measured on the basis of additional test internet traffic.

The passive measurement method is a method of measuring internet traffic by tapping physical link lines, separating lines using the port mirroring function of a switch or router, and installing an additional line for monitoring. This method, however, has a problem in that a network currently being operated must be temporarily stopped for the physical tapping of lines. Accordingly, the active measurement method is chiefly used because it meets the requirements of a network operator who wants to check and manage network conditions in real time and to efficiently operate a network without affecting the performance of a network.

An internet traffic analysis method includes an analysis method per packet and an analysis method per flow. The internet traffic analysis method based on the packet unit was chiefly used at the early stage. However, with a rapid increase in the number of Internet users and the volume of networks and internet traffic, the analysis method based on the unit of flow (i.e., a set of packets) has emerged and has been widely used. In the flow-based analysis method, packets, having common characteristics (e.g., a source IP address, a destination IP address, a source port, a destination port, a protocol ID, and a DSCP), are put together in the unit called a flow and then analyzed, instead of measuring and analyzing all packets per packet. The flow-based analysis method can greatly reduce the latency time of internet traffic analysis processing by analyzing internet traffic on the basis of a flow in which packets are put together according to predetermined criteria.

The flow-based analysis method includes IPFIX, and Flow-Tools is used as a representative analysis tool. The flow unit analysis tool is operated in a single server. Although the flow unit analysis tool may expect higher performance than the packet unit analysis method because of the recent increase of users and internet traffic, the flow unit analysis tool operated in a single server is problematic in that the internet traffic analysis speed may be degraded because the performance of the server serves as overhead. This problem is more serious in a router, processing high capacity internet traffic in a high-speed Internet network of several 100 Mbps to several 10 Gbps, and a system collecting and analyzing high capacity internet flow data. Consequently, in order to analyze internet flow data and transfer the analysis result to a user within a short period of time for the purpose of internet traffic measurement, the performance of a server must be high, thereby requiring expensive, high performance server.

Meanwhile, MapReduce is introduced by Google as a programming model for generating and processing high capacity data. MapReduce is being widely used in order to process data of large-scale web pages. Here, Map is a function of producing another (key′, value′) pair by processing a (key, value) pair. Since the Map functions are performed in numerous nodes at the same time, respective (key′, value′) data sets are produced. Reduce is a function of producing (key′, list(value′)) of a list form by merging the (key′, value′) data produced by the Map function, and a value having the same key. Since the Reduce functions are performed in numerous nodes at the same time, respective (key′, list(value′)) are finally merged to produce list(value′). Accordingly, if a user has only to write his Map function and Reduce function, parallel computations are possible along with all nodes within one cluster. MapReduce is applied to various kinds of distributed data processing, such as the extraction of a line, including a specific word, from a high capacity web document (i.e., distributed Grep) and the count of URL access frequency. However, an attempt has not yet been made to effectively process internet traffic by applying MapReduce to internet flow data processing.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Accordingly, the present invention has been made in view of the above problems occurring in the prior art, and it is an object of the present invention to provide a method of analyzing internet flow data, which is capable of improving the performance of internet traffic measurement and analysis in such a manner that internet traffic based on a flow is distributed into a plurality of servers and the respective servers analyze and process the distributed internet traffic in parallel.

To achieve the above object, according to the present invention, there is provided a method of analyzing internet flow data for internet traffic monitoring by performing parallel computations using a MapReduce method, which comprises: (A) an internet flow data input step of dividing internet flow data stored in a file system and receiving the divided data at one or more data nodes; (B) a Map task step of producing, with respect to each of the data nodes, a (Key, Value) pair from the received data and temporarily storing the (Key, Value) pair; and (C) a Reduce task step of calculating a (Key, SUM(Value)) value from the stored (Key, Value) value and storing the calculated (Key, SUM(Value)) value.

The term manager node, herein, refers to a server for managing the performance of the entire system and allocating tasks, and the term data node refers to a server for substantially analyzing and processing data. The present invention has been contrived to solve problems resulting from a reduction in the internet traffic analysis speed because internet flow data analysis is performed by a single server in the prior art. It is preferred that the number of data nodes be one or more. The analysis speed of internet flow data increases with an increase in the number of data nodes, as can be seen from FIG. 4, and thus it is advantageous to use a plurality of data nodes. For this reason, it is meaningless to set the least upper bound to the number of data nodes. However, those having ordinary skill in the art will easily determine a proper number of data nodes by taking the volume of a network (i.e., the object of internet flow data analysis) and environments and economical efficiency, such as the performance of the data node, into consideration.

The values Key and Value may be previously set by a user depending on the purposes for analysis. The Key may be a source IP address, a destination IP address, a source port number, or a destination port number, and the Value may be a number of flows, a number of packets, or a number of bytes. Internet flow data, such as the number of packets for each source IP address and the number of packets for each destination port number, can be analyzed on the basis of the set values Key and Value.

It is preferred that before the Map task step (B), the step of determining whether the received data is normal data is performed by checking whether at least one of a start time of a flow, an end time of a flow, a source IP address of a flow, a source port number of a flow, a destination IP address of a flow, a destination port address of a flow, a protocol type, a number of flows generated, a number of packets, and a number of bytes is omitted. If the data is determined not to be normal, the Map task step is not performed on the data. Such sorting of normal data may be performed in the manager node or the data nodes.

Furthermore, the method may further include a ranking decision step of sorting the (Key, SUM(Value) values, produced in the Reduce task step (C), in ascending powers or in descending powers on the basis of the SUM(Value) value. In the ranking decision step, an IP address having a large amount of flow transmitted, etc. can be easily analyzed.

### BRIEF DESCRIPTION OF THE DRAWINGS

Further objects and advantages of the invention can be more, fully understood from the following detailed description taken in conjunction with the accompanying drawings in which:

FIG. 1 is a flowchart illustrating a MapReduce-based internet flow data analysis method according to an embodiment of the present invention;

FIG. 2 is a detailed flowchart showing the step 102 of FIG. 1;

FIG. 3 is a detailed flowchart showing the step 103 of FIG. 1; and

FIG. 4 is a graph comparing the performance of an internet flow data analysis method according to an embodiment of the present invention with the performance of an existing flow-tools method.

### DETAILED DESCRIPTION OF EMBODIMENTS

Some embodiments of the present invention will now be described in detail with reference to the accompanying drawings. However, the embodiments are only illustrative, and the present invention is not limited thereto.

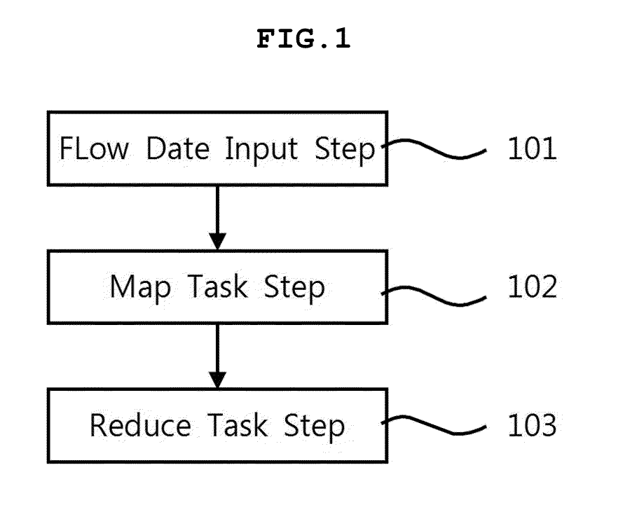

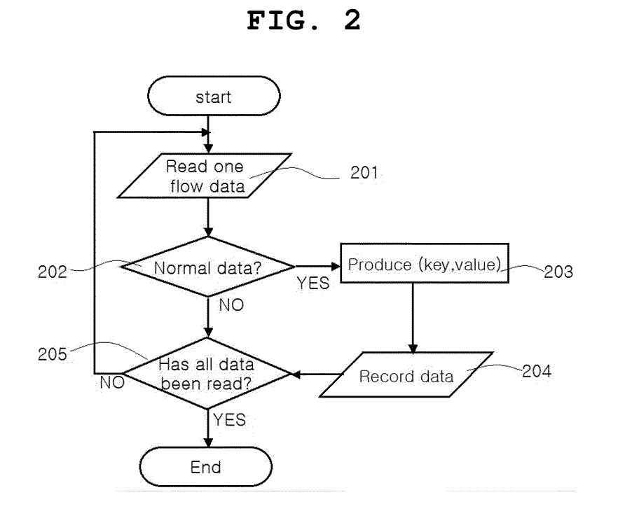

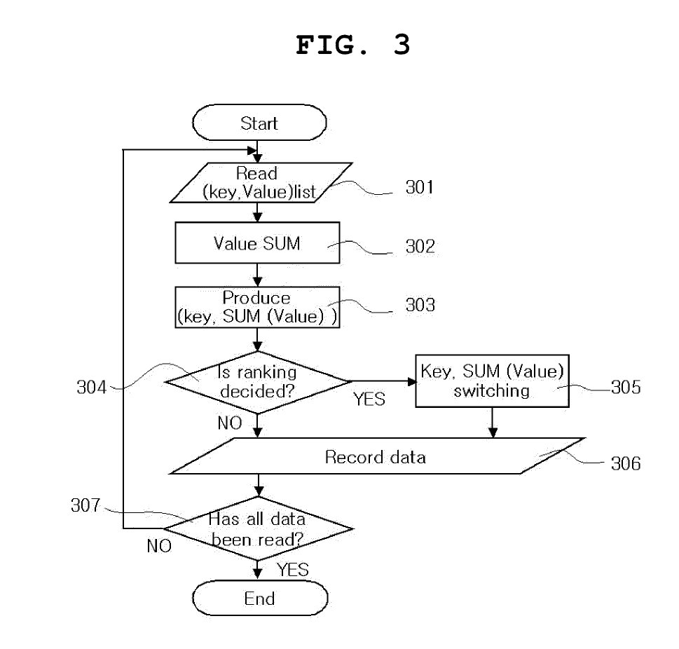

FIG. 1 is an overall flowchart illustrating an internet flow data analysis method for measurement of internet traffic according to an embodiment of the present invention. Referring to FIG. 1, the internet flow data analysis method includes an internet flow data input step 101, a Map task step 102, and a Reduce task step 103. FIGS. 2 and 3 are detailed flowcharts of the Map task step 102 and the Reduce task step 103 shown in FIG. 1.

In the internet flow data input step 101, a manager node reads internet flow data, stored in a file system, from respective lines and input the read internet flow data to respective data nodes.

In the Map task step 102, the data nodes receive and analyze the received data in the respective lines. Here, the data nodes may comprise one or more servers. Preferably, the server or servers may serve also as a Map task server.

Referring to FIG. 2, each of the data nodes reads the internet flow data in a corresponding line at step 201 and determines whether the internet flow data is normal data by checking the configuration value of the internet flow data of the line at step 202. That is, if, as a result of the determination, at least one of the start time of a flow, the end time of a flow, the source IP address of a flow, the source port number of a flow, the destination IP address of a flow, the destination port address of a flow, a protocol type, the number of generated flows, the number of packets, and the number of bytes in the each line is omitted, the data node determines that the received data is not normal data. The determination of whether the received data is normal data reduces the generation of error in the data analysis process.

In an embodiment, the determination may be performed in the internet flow data input step 101. For example, in the internet flow data input step 101, internet flow data in respective lines may be sequentially read, and it is determined whether the data is normal data. If, as a result of the determination, only when the data is normal data, the data may be allocated and inputted to the data nodes. In case where the determination is performed in the internet flow data input step 101, the Map task step 102 may be omitted.

If, as a result of the determination at step 202, the data is determined to be normal data, a (Key, Value) pair is produced by extracting values Key and Value, defined on the basis of a value set by a user, through character string analysis at step 203. The values Key and Value should be produced in pairs, and values not produced in pairs are treated as unnecessary values and discarded. Here, Key is a value for sorting, and one selected from among a source IP address, a destination IP address, a source port number, and a destination port number may be used as the value Key depending on measurement and analysis purposes of internet traffic. Value is a value capable of measuring internet traffic corresponding to the value Key. Data, such as the number of flows, the number of packets, or the number of bytes, may be used as the Value value. The generated (Key, Value) pair is temporarily recorded in a storage at step 204.

After the recording process for normal data is completed, it is determination whether there is any data that has been inputted by the manager node but has not been read at step 205. If, as a result of the determination, there is any such data, the process returns to step 201. On the other hand, if it is determined that there is no such data, the Map analysis task is completed.

If, as a result of the determination at step 202, the data is determined not to be normal data, the step 205 is performed.

In the Reduce task step 103, data nodes read the (Key, Value) pairs temporarily stored in the storage and produce respective results for internet flow data. Here, the data nodes may be the same data nodes responsible for the Map task or may be separately designated. Furthermore, the data nodes for the Reduce task may comprise one or more servers. The manager node may also play the role of the data nodes for the Reduce task.

The Reduce task step 103 is described in detail with reference to FIG. 3. In a (Key, Value) list read step 301, (Key, Value) pairs having the same Key value are read from the data list of (Key, Value) pairs temporarily recorded in the storage in the Map task step. SUM(Value) (i.e., a new Value value) is calculated at step 302 by adding the Value value of the read data, and a new pair (Key, SUM(Value)) is produced at step 303. For example, in case where the (Key, Value) pair is set to a pair of (an IP address, the number of flows), (an IP address, SUM(the number of flows)) is produced as described above, and thus the total number of flows according to the IP address may be calculated. The calculated pair (Key, SUM(Value)) is recorded at step 306 and may be used for internet traffic measurement and analysis. After the data recording step (306) is completed, it is determined whether all data temporarily recorded in the storage in the Map task step has been read at step 307. If it is determined that all the data temporarily recorded in the storage in the Map task step 102 has not been read, another Key value is selected, a (Key, Value) list is produced, and the above task is then repeatedly performed. On the other hand, if it is determined that all the data temporarily recorded in the storage in the Map task step 102 has been read, the Reduce task is terminated.

Data on which the Reduce task has been performed may be visualized by using rrdtool or php and used to monitor internet traffic. For example, a shift in the count of bytes during 5-minute interval for an IP address and a port number may be monitored. An IP address and a port number that have been recently most frequently used may be sorted in order to show a user network conditions.

Ranking for the (Key, SUM(Value)) pairs produced in the Reduce task step 103 may be additionally decided as the occasion demands at step 304. For example, in case where data, such as an IP address order having a large number of flows or a port number order having a large number of bytes, is required, the ranking decision step may be further performed between the step 303 and the step 306. In case where ranking decision according to the SUM(Value) values is necessary, ranking may be decided by transforming the (Key, SUM(Value)) pairs into (SUM(Value), Key) pairs through Key, SUM(Value) switching and sorting the (SUM(Value), Key) pairs according to the SUM(Value) value at step 305.

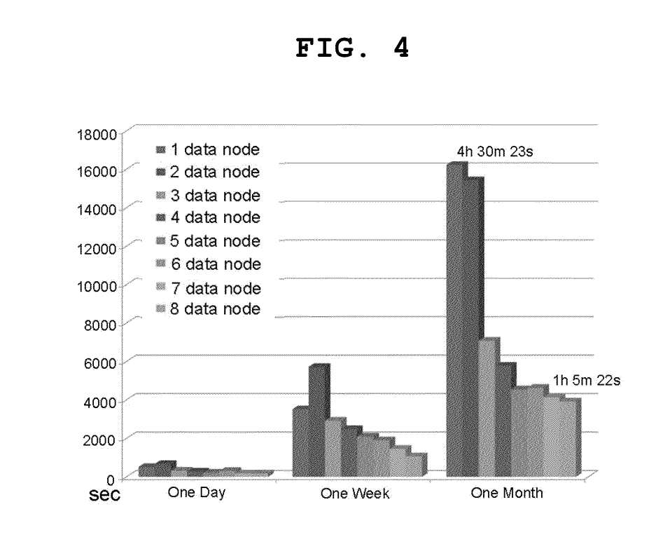

FIG. 4 is a graph showing a comparison of the performance of the internet flow data analysis method according to the embodiment of the present invention and the performance of an existing method using Flow-Tools. In FIG. 4, data nodes 1 to 7 are results obtained by performing the internet flow data analysis method according to the embodiment of the present invention using an increased number of data nodes. An X axis indicates the types of data used and experiment methods, and a Y axis indicates the time taken to perform the same task. Each of the experiment results reveals that performance is excellent with a smaller value in the y axis.

More particularly, the performance of the internet flow data analysis method according to the embodiment of the present invention was compared with results obtained by using the existing Flow-Tools method using internet flow data collected from a network of /24 subnet a day, one week, and one month, while increasing the number of data nodes aside from the manager node of MapReduce. That is, a case where one data node is used corresponds to a flow analysis result obtained by using one data node aside from the manager node. Here, the specification of the data node used is Intel Core2 Quad 2.83 GHz and 4 GB Memory. In this experiment, nodes allocated to the Map task and the Reduce task were automatically allocated by the manager node.

As shown in the internet flow data analysis of one month in FIG. 4, the performance of the method using the seven data node with MapReduce used is at least about 400% higher than that of the existing method using Flow-Tools. The one day and one week experiments showed the similar result.

As described above, according to the present invention, when internet flow data is analyzed for internet traffic analysis, the analysis task is not performed in one server, but distributed into a plurality of server and then performed. Accordingly, internet flow data can be analyzed within a shorter period.

Furthermore, according to the present invention, internet traffic analysis is not performed by a single server with excellent performance, but performed by a plurality of servers with common performance. Accordingly, costs can be reduced.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of analyzing internet flow data for internet traffic monitoring by performing parallel computations using a MapReduce method, the method comprising:
(A) an internet flow data input step of dividing internet flow data stored in a file system and receiving the divided data at one or more data nodes;
(B) a Map task step of producing, with respect to each of the data nodes, a (Key, Value) pair from the received data and temporarily storing the (Key, Value) pair; and
(C) a Reduce task step of calculating a (Key, SUM(Value)) value from the stored (Key, Value) value and storing the calculated (Key, SUM(Value)) value.

2. The method as claimed in claim 1, further comprising the step of determining whether the received data is normal data by checking the configuration value of the internet flow data.

3. The method as claimed in claim 2, the step of determining whether the received data is normal data is performed before the Map task step (B) by checking whether at least one of a start time of a flow, an end time of a flow, a source IP address of a flow, a source port number of a flow, a destination IP address of a flow, a destination port address of a flow, a protocol type, a number of flows generated, a number of packets, and a number of bytes is omitted.

4. The method as claimed in claim 1, further comprising a ranking decision step of sorting the (Key, SUM(Value) values produced in the Reduce task step (C), in ascending powers or in descending powers on the basis of the SUM(Value) value.

5. The method as claimed in claim 1, wherein:
the Key is a source IP address, a destination IP address, a source port number, or a destination port number, and
the Value is a number of flows, a number of packets, or a number of bytes.

6. The method as claimed in claim 5, further comprising the step of determining whether the received data is normal data by checking the configuration value of the internet flow data.

7. The method as claimed in claim 6, the step of determining whether the received data is normal data is performed before the Map task step (B) by checking whether at least one of a start time of a flow, an end time of a flow, a source IP address of a flow, a source port number of a flow, a destination IP address of a flow, a destination port address of a flow, a protocol type, a number of flows generated, a number of packets, and a number of bytes is omitted.

8. The method as claimed in claim 5, further comprising a ranking decision step of sorting the (Key, SUM(Value) values produced in the Reduce task step (C), in ascending powers or in descending powers on the basis of the SUM(Value) value.
